(19) United States
(12) Patent Application Publication
(10) Pub. No.: US 2013/0159788 A1
(43) Pub. Date: Jun. 20, 2013

(54) OPERATION VERIFICATION SUPPORT DEVICE, OPERATION VERIFICATION SUPPORT METHOD AND OPERATION VERIFICATION SUPPORT PROGRAM

(71) Applicants: Yuki Ashino, Tokyo (JP); Masayuki Nakae, Tokyo (JP)

(72) Inventors: Yuki Ashino, Tokyo (JP); Masayuki Nakae, Tokyo (JP)

(73) Assignee: NEC CORPORATION, Tokyo (JP)

(21) Appl. No.: 13/818,526

(22) PCT Filed: Sep. 15, 2011
(86) PCT No.: PCT/JP2011/071746

§ 371 Date: Feb. 22, 2013

(30) Foreign Application Priority Data
Sep. 16, 2010 (JP) 2010-207872

(51) Int. Cl. G06F 11/00

(52) U.S. Cl. CPC G06F 11/004
USPC 714/47.3

(57) ABSTRACT

At a time of operation verification of programs associated with an update of a shared program, information about a functionality necessary to be verified on a target program of operation verification can be presented.

An influence degree calculation unit 102 calculates an influence degree of an update of a shared file to be updated for a shared file referring directly or indirectly to the shared file to be updated, on the basis of the reference relationships. A verification support information generation unit 103 detects a shared file having the influence degree which is equal to or higher than a predetermined value from among shared files referred to directly or indirectly by a verification target application file, on the basis of the reference relationships and the influence degree, and outputs information about a function call included in the detected shared file as information on a functionality necessary to be verified on the verification target application file.

### TECHNICAL FIELD

The present invention relates to an operation verification support device, an operation verification support method and an operation verification support program, and more particularly to an operation verification support device, an operation verification support method and an operation verification support program which support operation verification associated with update of a program file.

### BACKGROUND ART

Programs of a computer system such as a personal computer (PC) are updated daily for the purpose of a functional upgrade or fixing of bugs or the like. By installing an updated program into a computer system, a functional upgrade or problem fixing of a program existing in the computer system is achieved.

Among such programs, a shared program is mentioned as a program updated particularly often. A shared program is a program which provides a functionality for other programs (shared by the other programs), as a library, for example. Through an update of a shared program, a functional upgrade or bug fixing of other programs using the shared program is achieved.

However, there is a case where some programs strongly depend on a specific version of a shared program. In this case, there is a possibility that some of the other programs become unable to operate owing to an update of the shared program, even if the purpose of the update is a functional upgrade or bug fixing. Therefore, when a shared program is updated, for example, a maintenance personnel in charge of maintenance of the computer system needs to perform operation verification of the computer system.

However, to such a maintenance personnel, generally, no information is provided about which program refers to which shared program. Additionally, there is also a case where an updated shared program is referred to by another shared program. Accordingly, it is difficult for the maintenance personnel to predict an extent of the influence of an update of a shared program. For this reason, the maintenance personnel needs to perform operation verification on an enormous number of programs existing in the computer system,

An example of a system for solving this problem is described in Patent Literature 1. In a software development support method described in Patent Literature 1, by registering various resources generated during a program development process in various databases, a degree of influence (influence degree) of an update of a certain program for other programs and an extent of the influence are obtained. Using this method, the maintenance personnel can know a program influenced by an update of a shared program and an influence degree for it. Accordingly, by determining a program with a high influence degree to be a program necessary to be verified (a target of operation verification), the maintenance personnel can efficiently perform operation verification of the computer system.

### CITATION LIST

### Patent Literature

[Patent Literature 1] Japanese Patent Application Laid-Open No. H09-016392

### SUMMARY OF INVENTION

### Technical Problem

The above-mentioned software development support method described in Patent Literature 1 makes it possible to extract a target program of operation verification on the basis of an influence degree of an update of a shared program. However, it generates no information for estimating which one of functionalities held by the extracted program is influenced by the update of the shared program. Accordingly, the maintenance personnel needs to perform operation verification on all of the functionalities provided by the program extracted as a target of the operation verification.

The objective of the present invention is to, solving the problem mentioned above, provide an operation verification support device, an operation verification support method and an operation verification support program which, at a time of operation verification of programs associated with an update of a shared program, present information about a functionality necessary to be verified on a verification target program.

### Solution to Problem

An operation verification support device according to an exemplary aspect of the invention includes reference relationship detection means for detecting reference relationships between a plurality of program files stored in a program file storing means, influence degree calculation means for calculating an influence degree of an update of a first program file among the plurality of program files for a program file referring directly or indirectly to the first program, on the basis of the reference relationships, and verification support information generation means for detecting a third program file having the influence degree which is equal to or higher than a predetermined value from among program files referred to directly or indirectly by a second program file, on the basis of the reference relationships and the influence degree, the second and third program files being among program files referring directly or indirectly to the first program file, and outputting information about a function call included in the third program file as information on a functionality necessary to be verified on the second program file.

An operation verification support method according to an exemplary aspect of the invention includes detecting reference relationships between a plurality of program files stored in a program file storing means, calculating an influence degree of an update of a first program file among the plurality of program files for a program file referring directly or indirectly to the first program, on the basis of the reference relationships, and detecting a third program file having the influence degree which is equal to or higher than a predetermined value from among program files referred to directly or indirectly by a second program file, on the basis of the reference relationships and the influence degree, the second and third program files being among program files referring directly or indirectly to the first program file, and outputting information about a function call included in the third program file as information on a functionality necessary to be verified on the second program file.

A computer readable storage medium according to an exemplary aspect of the invention, records thereon an operation verification support program, causing a computer to perform a method including detecting reference relationships between a plurality of program files stored in a program file storing means, calculating an influence degree of an update of a first program file among the plurality of program files for a program file referring directly or indirectly to the first program, on the basis of the reference relationships, and detecting a third program file having the influence degree which is equal to or higher than a predetermined value from among program files referred to directly or indirectly by a second program file, on the basis of the reference relationships and the influence degree, the second and third program files being among program files referring directly or indirectly to the first program file, and outputting information about a function call included in the third program file as information on a functionality necessary to be verified on the second program file.

### Advantageous Effect of the Invention

The advantageous effect of the present invention is capability of presenting information about a functionality necessary to be verified on a target program of operation verification, at a time of operation verification of programs associated with an update of a shared program.

### BRIEF DESCRIPTION OF DRAWINGS

FIG. 1 A block diagram showing a characteristic configuration according to a first exemplary embodiment of the present invention.

FIG. 2 A block diagram showing a configuration of an operation verification support device 100 according to the first exemplary embodiment of the present invention.

FIG. 3 A flow chart showing operation of the operation verification support device 100 according to the first exemplary embodiment of the present invention.

FIG. 4 A diagram showing an example of reference relationships between program files according to the first exemplary embodiment of the present invention.

FIG. 5 A diagram showing an example of a reference relationship table 121 according to the first exemplary embodiment of the present invention.

FIG. 6 A diagram showing an example of an influence degree table 122 according to the first exemplary embodiment of the present invention.

FIG. 7 A diagram showing an example of function information 123 according to the first exemplary embodiment of the present invention.

### DESCRIPTION OF EMBODIMENTS

### First Exemplary Embodiment

Next, a first exemplary embodiment of the present invention will be described in detail, with reference to drawings.

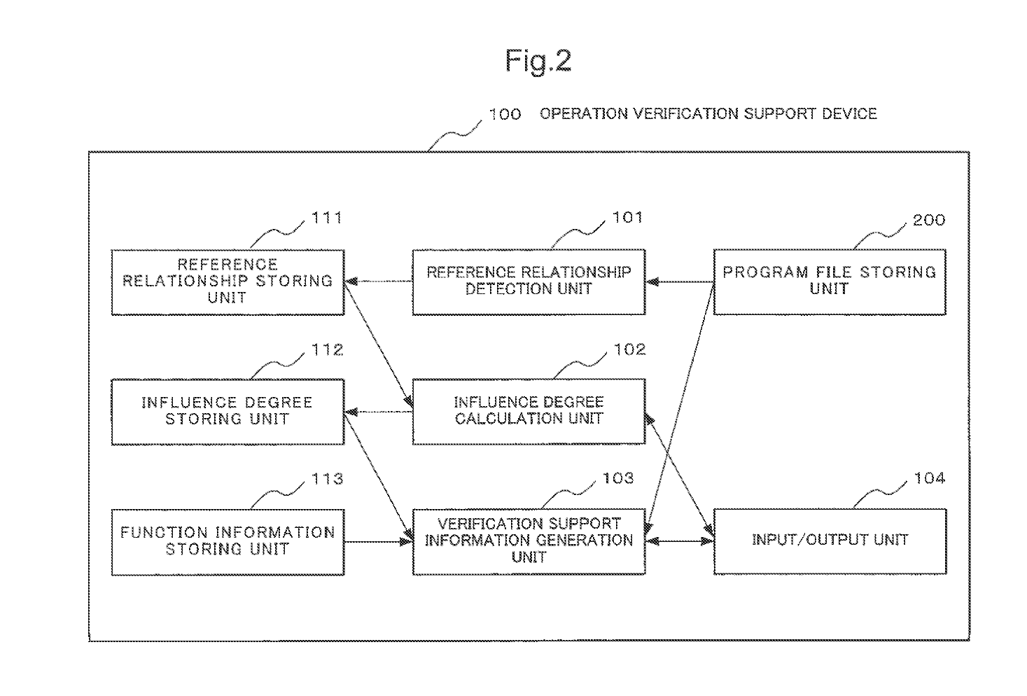

First, a configuration of an operation verification support device 100 in the first exemplary embodiment of the present invention will be described. FIG. 2 is a block diagram showing a configuration of the operation verification support device 100 according to the first exemplary embodiment of the present invention.

Referring to FIG. 2, the operation verification support device 100 according to the first exemplary embodiment of the present invention includes a reference relationship detection unit 101, an influence degree calculation unit 102, a verification support information generation unit 103, an input/output unit 104, a reference relationship storing unit 111, an influence degree storing unit 112, a function information storing unit 113 and a program file storing unit 200.

Here, the program file storing unit 200 is composed of a recording medium of a computer system such as a PC, for example. In the program file storing unit 200, an operating system such as Windows (registered trademark) and application programs working on the operating system are installed.

In the program file storing unit 200, shared files containing the operating system or shared programs such as libraries other than the operating system (for example, dll files in the case of Windows (registered trademark)), and application files containing the application programs (for example, exe files in the case of Windows (registered trademark)) are stored as program files.

Each of the application files directly refers to a predetermined shared file. Each of the shared files also directly refers to a predetermined other shared file.

Here, “file A directly refers to file B” means that file A directly uses a function call provided by file B. Further, “file A indirectly refers to file B” means that, such as in a case where file A directly refers to file C, file C directly refers to file D, and file D further refers directly to file B, direct reference by a file other than files A and B is sequentially performed between files A and B. Hereafter, simple descriptions “reference” and “reference relationship” represent direct reference and a direct reference relationship, respectively, unless otherwise noted.

Here, each of the application files and shared files includes reference file information 131 which represents an identifier of the other shared file (file name) the application file or the shared file is referring to, and an identifier of a function call (a name of a function call) the application file or the shared file is referring to among the function calls provided by the shared file. Further, each of the shared files includes provided function information 132 which represents a name of a function call provided by the shared file to the application files or the other shared files.

For example, in the case of Windows (registered trademark), application files and shared files each include an import section as reference file information 131. Further, the shared files each include an export section as provided function information 132.

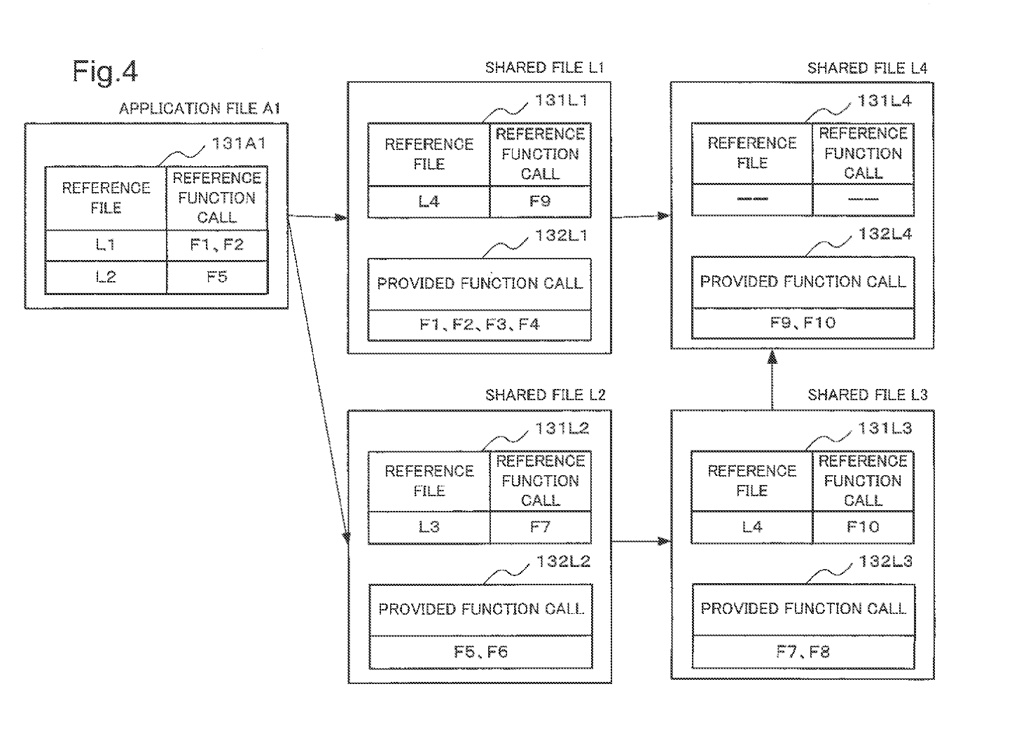

FIG. 4 is a diagram showing an example of reference relationships between program files according to the first exemplary embodiment of the present invention. In FIG. 4, arrows between the program files (an application file, shared files) indicate respective reference relationships. In this case, the application file with a file identifier A1 includes reference file information 131A1 shown in FIG. 4, and the shared files with file identifiers L1, L2, . . . include reference file information 131L1, L2, . . . shown in FIG. 4, respectively. Further, the shared files with file identifiers L1, L2, . . . also include provided function information 132L1, L2, . . . shown in FIG. 4, respectively.

The reference relationship detection unit 101 detects reference relationships between a plurality of program files stored in the program file storing unit 200, and thereby generates a reference relationship table 121.

The reference relationship storing unit 111 stores the reference relationship table 121 generated by the reference relationship detection unit 101.

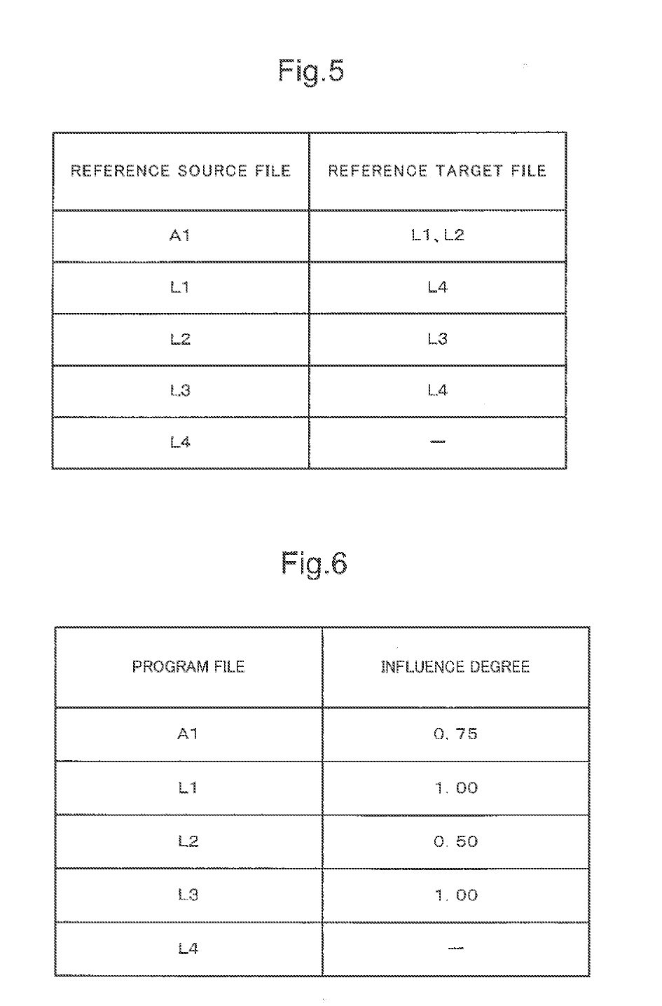

FIG. 5 is a diagram showing an example of a reference relationship table 121 according to the first exemplary embodiment of the present invention. As shown in FIG. 5, the reference relationship table 121 shows the identifier of a program file which is a reference target, for each of identifiers of program files which are reference sources.

The influence degree calculation unit 102 calculates an influence degree of an update of a shared file, with respect to each program referring directly or indirectly to the shared program to be updated (first program file) among the plurality of program files stored in the program file storing unit 200, on the basis of the reference relationship table 121, and thereby generates an influence degree table 122.

The influence degree storing unit 112 stores in it the influence degree table 122 generated by the influence degree calculation unit 102.

FIG. 6 is a diagram showing an example on an influence degree table 122 according to the first exemplary embodiment of the present invention. As shown in FIG. 6, the influence degree table 122 presents an influence degree of an update of a shared file to be updated, for each program file identifier.

When a verification target application file (second program file) is designated among the program files referring directly or indirectly to the shared program to be updated, the verification support information generation unit 103 detects a shared file with a high influence degree (third program file) from among the shared programs referred to directly or indirectly by the application file, on the basis of the reference relationship table 121 and the influence degree table 122. Further, the verification support information generation unit 103 outputs information about a function call included in the shared file with a high influence degree, as information on a functionality necessary to be verified on the designated application file.

The function information storing unit 113 stores in it function information 123 representing the contents of functionalities provided by function calls included in the program files stored in the program file storing unit 200.

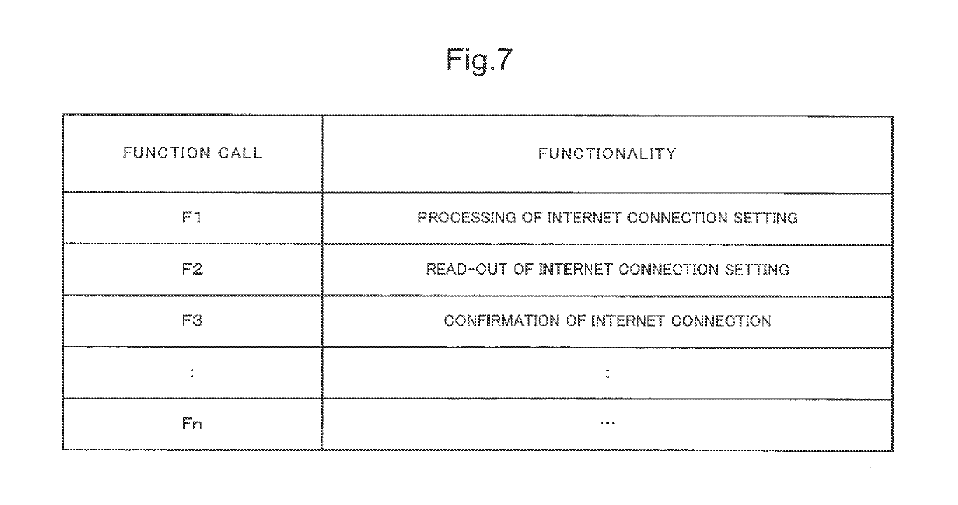

FIG. 7 is a diagram showing an example of function information 123 according to the first exemplary embodiment of the present invention. As shown in FIG. 7, the function information 123 presents information for describing a function call, such as a functionality or a role provided by the function call, for each function call identifier (function call name).

The input/output unit 104 is an input/output interface with a user (maintenance personnel) performing operation verification, which comprises an LCD (Liquid Crystal Display), keyboard, mouse, speaker and the like.

Note that, the operation verification support device 100 may be a computer which comprises a CPU (Central Processing Unit) and a recording medium storing the programs, and operates under control based on a program. Further, the reference relationship storing unit 111, the influence degree storing unit 112, the function information storing unit 113 and the program file storing unit 200 may be configured either with respectively separated recording mediums or with a single recording medium.

In such a case, the operation verification support device 100 may be realized as, for example, a program on a computer system such as a PC, where the reference relationship storing unit 111, the influence degree storing unit 112, the function information storing unit 113 and the program file storing unit 200 may be configured with a recording medium (or recording mediums) of the computer system.

Further, the program file storing unit 200 may exist outside the operation verification support device 100 and be connected to the operation verification support device 100 by a connection unit or via a network or the like, not shown in the figures. Similarly, the function information storing unit 113 may be a database provided outside the operation verification support device 100.

Next, operation of the operation verification support device 100 in the first exemplary embodiment of the present invention will be described.

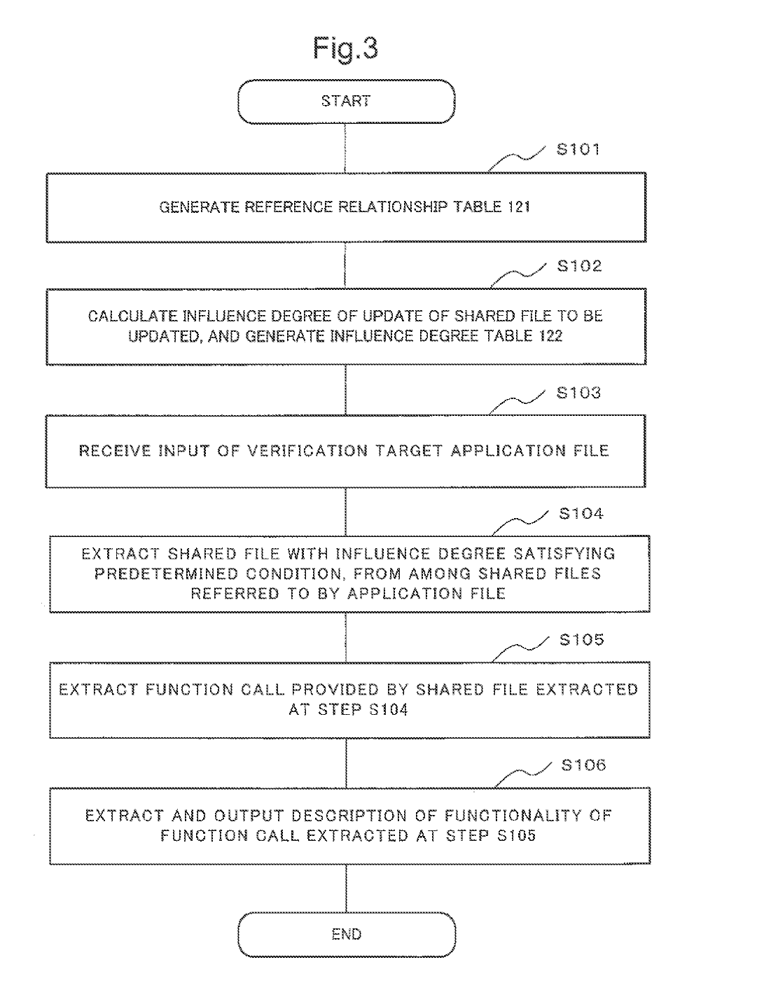

FIG. 3 is a flow chart showing operation of the operation verification support device 100 according to the first exemplary embodiment of the present invention.

First, the reference relationship detection unit 101 detects reference relationships between program files stored in the program file storing unit 200, and thereby generates a reference relationship table 121, and stores it in the reference relationship storing unit 111 (step S101). Here, the reference relationship detection unit 101 extracts shared files referred to by the respective program files on the basis of reference file information 131 regarding the program files stored in the program file storing unit 200, and thereby generates the reference relationship table 121.

For example, with respect to the reference relationships between the program files shown in FIG. 4, the reference relationship detection unit 101 generates the reference relationship table 121 shown in FIG. 5.

Next, the influence degree calculation unit 102 calculates, for each of program files referring directly or indirectly to a shared file to be updated, an influence degree of an update of the shared file on the basis of the reference relationship table 121 stored in the reference relationship storing unit 111, and thereby generates an influence degree table 122, and stores it in the influence degree storing unit 112 (step S102). Here, the identifier of the shared file to be updated may be designated by a user using the input/output unit 104, or may be designated by a table or the like, set in advance by the user, in which the identifier of the shared file to be updated is described.

In the exemplary embodiment of the present invention, it is assumed that the influence degree takes a maximum value when a program file subjected to influence degree calculation refers directly to the shared program to be updated, and it takes a smaller value with increasing the number of shared programs existing between a program file subjected to influence degree calculation and the shared program to be updated, in the reference relationships between the program files.

According to this assumption, the influence degree calculation unit 102 calculates an influence degree by, for example, the following rules.

(1) When a program file subjected to influence degree calculation directly refers to the shared file to be updated, the influence degree is one.

(2) For every increase by one in the number of shared programs existing between the shared file to be updated and a program file subjected to influence degree calculation, in the reference relationships between the program files, the influence degree is halved.

(3) When there are a plurality of paths between the shared file to be updated and a program file subjected to influence degree calculation in the reference relationships between the program files, the influence degree for the program file subjected to the calculation is a total of influence degrees calculated for the respective paths.

(4) No path between the shared file to be updated and a program file subjected to influence degree calculation passes through an identical shared program twice or more.

For example, when the reference relationship table 121 shown in FIG. 5 is generated with regard to the reference relationships between the program files shown in FIG. 4, and the shared file with the file identifier L4 is the shared file to be updated, the influence degree is 1.0 for both the shared files with the respective file identifiers L1 and L3, which directly refer to the shared file with the file identifier L4. Because one shared file (with the file identifier L3) exists between the shared file with the file identifier L4 and that with L2, the influence degree is 0.5 for the shared file with the file identifier L2. Between the shared file with the file identifier L4 and the application file with the file identifier A1, there exist two paths; one passing through the shared file with the file identifier L1 and the other through the shared files with the file identifiers L2 and L3. For the path passing through the shared file with the file identifier L1, because one shared file exists on it, the influence degree is 0.5. For the path passing through the shared files with the file identifiers L2 and L3, because two shared files exist on it, the influence degree is 0.25. The influence degree for the application file with the file identifier A1 is a total of these two values that is 0.75.

As a result of the above calculations, influence degrees are set in the influence degree table 122 as shown in FIG. 6.

Next, the verification support information generation unit 103 receives a user's input of an identifier of a verification target application file through the input/output unit 104 (step S103). Here, the verification target application file may be any one of application files referring directly or indirectly to the shared file to be updated. The user selects, for example, an application file with a high influence degree as a verification target, on the basis of the influence degree table 122 generated at the step S102, and inputs its identifier.

For example, the verification support information generation unit 103 receives input of the file identifier A1 as a verification target application file.

Next, the verification support information generation unit 103 extracts a shared file on which the influence degree is equal to or higher than a predetermined value set in advance by the user or the like from among shared files referred to directly or indirectly by the application file, on the basis of the reference relationship table 121 stored in the reference relationship storing unit 111 and the influence degree table 122 stored in the influence degree storing unit 112 (step S104). Here, the verification support information generation unit 103 may extract a shared file with the highest influence degree.

For example, the verification support information generation unit 103 extracts the shared files with the respective file identifiers L1 and L3 as shared files on which the influence degree is equal to or higher than 1.0, from among the shared files (with the file identifiers L1, L2 and L3) referred to by the application file with the file identifier A1, on the basis of the reference relationship table 121 shown in FIG. 5 and the influence degree table 122 in FIG. 6.

Next, the verification support information generation unit 103 extracts an identifier of a function call provided by the shared file, on the basis of provided function information 132, for the shared file extracted at the step S104 (step S105).

For example, the verification support information generation unit 103 extracts the identifiers F1, F2, F3 and F4 of the respective function calls provided by the shared file, on the basis of the provided function information 132, for the shared file with the file identifier L1 in FIG. 4. The verification support information generation unit 103 also extracts the identifiers F7 and F8 of the respective function calls provided by the shared file, on the basis of the provided function information 132, for the shared file with the file identifier L3 in FIG. 4.

Further, the verification support information generation unit 103 extracts a description of the functionality of the function call extracted at the step S 105, and outputs it through the input/output unit 104 as information on a functionality necessary to be verified, on the basis of the function information 123 stored in the function information storing unit 113 (step S106).

For example, the verification support information generation unit 103 outputs the description of the functionality of each of the function calls with the respective function call identifiers F1, F2, F3, F4, F7 and F8, on the basis of the function information 123 in FIG. 7.

As a result, the user can perform operation verification, limiting functionalities to be verified to the functionalities outputted at the step S106 or functionalities using the outputted functionalities (functionalities related to the outputted functionalities), from among all functionalities of the verification target application file.

For example, when a program stored in the verification target application file is one which works according to a plurality of commands inputted by the user, and communicates with another computer system by making a connection to the internet only when a specific command is inputted, and the functionalities outputted at the step S106 are ones related to internet connection, the user can perform operation verification, limiting commands for the verification to those by which a connection to the internet is made, from among all commands to be inputted to the verification target application file.

Here, if the user can estimate the functionality of a function call provided by a shared file from the identifier of the function call, the function call identifier itself may be outputted at the step S106 instead of the description of the functionality of the function call.

Further, if a shared file extracted at the step S104 as one with an influence degree equal to or higher than a predetermined value is a shared file directly referred to by the verification target application file, the verification support information generation unit 103 may extract only the identifier of a function call referred to by the verification target application file, among all function calls provided by the shared file, at the step S105, on the basis of the reference file information 131 for the verification target application file.

For example, because the application file with the file identifier A1 directly refers to the shared file with the file identifier L1, the verification support information generation unit 103 extracts the identifiers F1 and F2 of the respective function calls referred to by the application file with the file identifier A1, from among the identifiers F1, F2, F3 and F4 of the respective function calls provided by the shared file.

As a result, it becomes possible to further limit functionalities necessary to be verified, which are outputted at the step S106.

In this way, operation of the first exemplary embodiment of the present invention is completed.

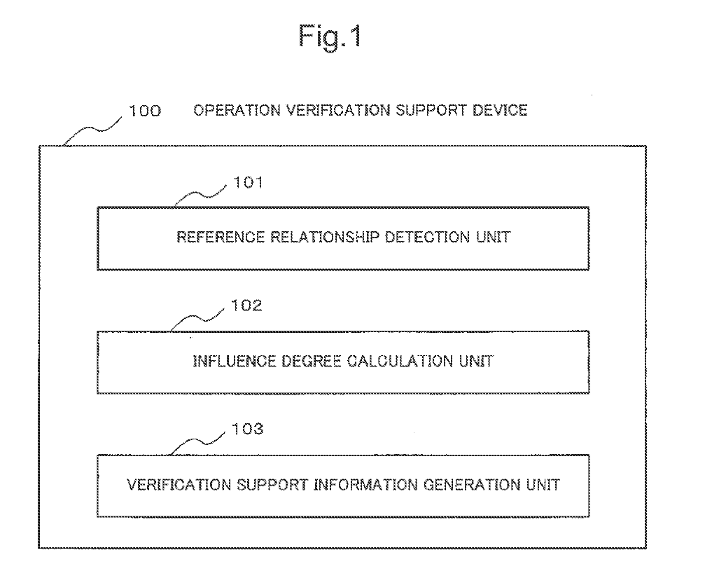

Next, a characteristic configuration of the first exemplary embodiment of the present invention will be described. FIG. 1 is a block diagram showing a characteristic configuration according to the first exemplary embodiment of the present invention.

An operation verification support device 100 includes a reference relationship detection unit 101, an influence degree calculation unit 102, and a verification support information generation unit 103.

The reference relationship detection unit 101 detects reference relationships between a plurality of program files stored in a program file storing unit 200.

The influence degree calculation unit 102 calculates an influence degree of an update of a first program file among the plurality of program files for a program file referring directly or indirectly to the first program, on the basis of the reference relationships.

The verification support information generation unit 103 detects a third program file having the influence degree which is equal to or higher than a predetermined value from among program files referred to directly or indirectly by a second program file, on the basis of the reference relationships and the influence degree, the second and third program files being among program files referring directly or indirectly to the first program file, and outputs information about a function call included in the third program file as information on a functionality necessary to be verified on the second program file.

According to the first exemplary embodiment of the present invention, at a time of operation verification of programs associated with an update of a shared program, information about a functionality necessary to be verified on a target program of operation verification can be presented. It is because the influence degree calculation unit 102 calculates an influence degree of an update of a shared file to be updated for each shared file referring directly or indirectly to the shared file to be updated on the basis of reference relationships between program files, and the verification support information generation unit 103 detects a shared file with an influence degree equal to or higher than a predetermined value from among shared files referred to by a verification target application file on the basis of the reference relationships and the influence degrees, and outputs information about a function call included in the detected shared file as information about a functionality necessary to be verified on the verification target application file.

As a result, a user can create verification items limiting them to functionalities necessary to be verified among all functionalities of the verification target application file, and thus the user can perform operation verification of a computer system more efficiently.

Further, according to the first exemplary embodiment of the present invention, even without program source codes and detailed documents, an influence degree of an update of a shared file for each program file can be calculated. It is because the reference relationship detection unit 101 extracts a shared file referred to by each program file on the basis of reference file information 131 included in each program file, and thereby detects reference relationships between the program files, and the influence calculation unit 102 calculates an influence degree of an update of a shared file for each program file on the basis of the reference relationships.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, in the first exemplary embodiment of the present invention, an influence degree is calculated in a manner to halve it for every increase by one in the number of shared programs existing between a shared program to be updated and a program file subjected to the influence degree calculation, in reference relationships between program files. The influence degree calculation may be performed by the use of any other method in which an influence degree decreases with increasing the number of intervening shared files, such as a method where predetermined fixed values are set in dependence on the number.

Further, in the first exemplary embodiment of the present invention, the calculation method of an influence degree for a program file is described taking the case of only one shared file to be updated, as an example. If there are a plurality of shared files to be updated, a total of influence degrees calculated in terms of the respective shared files to be updated may be determined as an influence degree for the program file.

Further, in the first exemplary embodiment of the present invention, a verification target application file is designated by a user. The verification support information generation unit 103 may select an application file with an influence degree satisfying a predetermined condition, on the basis of an influence degree table 122. Furthermore, the verification support information generation unit 103 may select each of a plurality of application files sequentially as a verification target, and output information about a functionality to be verified with respect to each of the application files.

This application is based upon and claims the benefit of priority from Japanese Patent Application No. 2010-207872, filed on Sep. 16, 2010, the disclosure of which is incorporated herein in its entirety by reference.

A part or the whole of the above-described exemplary embodiment can be described as, but not limited to, the following supplementary notes.
(Supplementary note 1) An operation verification support device comprising:

reference relationship detection means for detecting reference relationships between a plurality of program files stored in a program file storing means;

influence degree calculation means for calculating an influence degree of an update of a first program file among said plurality of program files for a program file referring directly or indirectly to said first program, on the basis of said reference relationships; and

verification support information generation means for detecting a third program file having said influence degree which is equal to or higher than a predetermined value from among program files referred to directly or indirectly by a second program file, on the basis of said reference relationships and said influence degree, said second and third program files being among program files referring directly or indirectly to said first program file, and outputting information about a function call included in said third program file as information on a functionality necessary to be verified on said second program file.
(Supplementary note 2) The operation verification support device according to supplementary note 1, wherein,

when a program file subjected to calculation of said influence degree directly refers to said first program file, said influence degree takes a maximum value, and

when a program file subjected to calculation of said influence degree indirectly refers to said first program file, said influence degree decreases in accordance with the number of program files between said first program file and the program file subjected to calculation of said influence degree in said reference relationships.
(Supplementary note 3) The operation verification support device according to supplementary note 1 or 2, wherein

said verification target function output means outputs a functionality provided by said function call included in said third program file as said information about a function call included in said third program file.
(Supplementary note 4) The operation verification support device according to any one of supplementary notes 1 to 3, wherein said verification target function output means outputs information about a function call used by said second program file among function calls included in said third program file when said second program file directly refers to said third program file.
(Supplementary note 5) An operation verification support method comprising:

detecting reference relationships between a plurality of program files stored in a program file storing means;

calculating an influence degree of an update of a first program file among said plurality of program files for a program file referring directly or indirectly to said first program, on the basis of said reference relationships; and

detecting a third program file having said influence degree which is equal to or higher than a predetermined value from among program files referred to directly or indirectly by a second program file, on the basis of said reference relationships and said influence degree, said second and third program files being among program files referring directly or indirectly to said first program file, and outputting information about a function call included in said third program file as information on a functionality necessary to be verified on said second program file.
(Supplementary note 6) The operation verification support method according to supplementary note 5, wherein,

when a program file subjected to calculation of said influence degree directly refers to said first program file, said influence degree takes a maximum value, and

when a program file subjected to calculation of said influence degree indirectly refers to said first program file, said influence degree decreases in accordance with the number of program files between said first program file and the program file subjected to calculation of said influence degree in said reference relationships.
(Supplementary note 7) The operation verification support method according to supplementary note 5 or 6, wherein,

said outputting outputs a functionality provided by said function call included in said third program file as said information about a function call included in said third program file.
(Supplementary note 8) The operation verification support method according to any one of supplementary notes 5 to 7, wherein,

said outputting outputs information about a function call used by said second program file among function calls included in said third program file when said second program file directly refers to said third program file.
(Supplementary note 9) A computer readable storage medium recording thereon an operation verification support program, causing a computer to perform a method comprising:

detecting reference relationships between a plurality of program files stored in a program file storing means;

calculating an influence degree of an update of a first program file among said plurality of program files for a program file referring directly or indirectly to said first program, on the basis of said reference relationships; and

detecting a third program file having said influence degree which is equal to or higher than a predetermined value from among program files referred to directly or indirectly by a second program file, on the basis of said reference relationships and said influence degree, said second and third program files being among program files referring directly or indirectly to said first program file, and outputting information about a function call included in said third program file as information on a functionality necessary to be verified on said second program file.
(Supplementary note 10) The computer readable storage medium according to supplementary note 9, recording thereon said operation verification support program causing said computer to perform said method, wherein,

when a program file subjected to calculation of said influence degree directly refers to said first program file, said influence degree takes a maximum value, and

when a program file subjected to calculation of said influence degree indirectly refers to said first program file, said influence degree decreases in accordance with the number of program files between said first program file and the program file subjected to calculation of said influence degree in said reference relationships.
(Supplementary note 11) The computer readable storage medium according to supplementary note 9 or 10, recording thereon said operation verification support program causing said computer to perform said method, wherein,

said outputting outputs a functionality provided by said function call included in said third program file as said information about a function included in said third program file.
(Supplementary note 12) The computer readable storage medium according to any one of supplementary notes 9 to 11, recording thereon said operation verification support program causing said computer to perform said method, wherein,

said outputting outputs information about a function call used by said second program file among function calls included in said third program file when said second program file directly refers to said third program file.

### INDUSTRIAL APPLICABILITY

The present invention can be applied to operation verification of a program at a time of updating a program file, which is performed, for example, as a part of maintenance services of a PC, and the like.

### REFERENCE SIGNS LIST

100 operation verification support device

101 reference relationship detection unit

102 influence degree calculation unit

103 verification support information generation unit

104 input/output unit

111 reference relationship storing unit

112 influence degree storing unit

113 function information storing unit

121 reference relationship table

122 influence degree table

123 function information

131 reference file information

132 provided function information

200 program file storing unit

1. An operation verification support device comprising:
a reference relationship detection unit which detects reference relationships between a plurality of program files stored in a program file storing means unit;
an influence degree calculation unit which calculates an influence degree of an update of a first program file among said plurality of program files for a program file referring directly or indirectly to said first program, on the basis of said reference relationships; and
a verification support information generation unit which detects a third program file having said influence degree which is equal to or higher than a predetermined value from among program files referred to directly or indirectly by a second program file, on the basis of said reference relationships and said influence degree, said second and third program files being among program files referring directly or indirectly to said first program file, and outputs information about a function call included in said third program file as information on a functionality necessary to be verified on said second program file.

2. The operation verification support device according to claim 1, wherein,
when a program file subjected to calculation of said influence degree directly refers to said first program file, said influence degree takes a maximum value, and
when a program file subjected to calculation of said influence degree indirectly refers to said first program file, said influence degree decreases in accordance with the number of program files between said first program file and the program file subjected to calculation of said influence degree in said reference relationships.

3. The operation verification support device according to claim 1, wherein
said verification support information generation unit outputs a functionality provided by said function call included in said third program file as said information about a function call included in said third program file.

4. The operation verification support device according to claim 1, wherein
said verification support information generation unit outputs information about a function call used by said second program file among function calls included in said third program file when said second program file directly refers to said third program file.

5. An operation verification support method comprising:
detecting reference relationships between a plurality of program files stored in a program file storing means;
calculating an influence degree of an update of a first program file among said plurality of program files for a program file referring directly or indirectly to said first program, on the basis of said reference relationships; and
detecting a third program file having said influence degree which is equal to or higher than a predetermined value from among program files referred to directly or indirectly by a second program file, on the basis of said reference relationships and said influence degree, said second and third program files being among program files referring directly or indirectly to said first program file, and outputting information about a function call included in said third program file as information on a functionality necessary to be verified on said second program file.

6. The operation verification support method according to claim 5, wherein,
when a program file subjected to calculation of said influence degree directly refers to said first program file, said influence degree takes a maximum value, and
when a program file subjected to calculation of said influence degree indirectly refers to said first program file, said influence degree decreases in accordance with the number of program files between said first program file and the program file subjected to calculation of said influence degree in said reference relationships.

7. A non-transitory computer readable storage medium recording thereon an operation verification support program, causing a computer to perform a method comprising:
detecting reference relationships between a plurality of program files stored in a program file storing means;
calculating an influence degree of an update of a first program file among said plurality of program files for a program file referring directly or indirectly to said first program, on the basis of said reference relationships; and
detecting a third program file having said influence degree which is equal to or higher than a predetermined value from among program files referred to directly or indirectly by a second program file, on the basis of said reference relationships and said influence degree, said second and third program files being among program files referring directly or indirectly to said first program file, and outputting information about a function call included in said third program file as information on a functionality necessary to be verified on said second program file.

8. The non-transitory computer readable storage medium according to claim 7, recording thereon said operation verification support program causing said computer to perform said method, wherein,
when a program file subjected to calculation of said influence degree directly refers to said first program file, said influence degree takes a maximum value, and
when a program file subjected to calculation of said influence degree indirectly refers to said first program file, said influence degree decreases in accordance with the number of program files between said first program file and the program file subjected to calculation of said influence degree in said reference relationships.

9. The non-transitory computer readable storage medium according to claim 7, recording thereon said operation verification support program causing said computer to perform said method, wherein,
said outputting outputs a functionality provided by said function call included in said third program file as said information about a function call included in said third program file.

10. The non-transitory computer readable storage medium according to claims 7, recording thereon said operation verification support program causing said computer to perform said method, wherein,
said outputting outputs information about a function call used by said second program file among function calls included in said third program file when said second program file directly refers to said third program file.

11. An operation verification support device comprising:
reference relationship detection means for detecting reference relationships between a plurality of program files stored in a program file storing means;
influence degree calculation means for calculating an influence degree of an update of a first program file among said plurality of program files for a program file referring directly or indirectly to said first program, on the basis of said reference relationships; and
verification support information generation means for detecting a third program file having said influence degree which is equal to or higher than a predetermined value from among program files referred to directly or indirectly by a second program file, on the basis of said reference relationships and said influence degree, said second and third program files being among program files referring directly or indirectly to said first program file, and outputting information about a function call included in said third program file as information on a functionality necessary to be verified on said second program file.
